(19) United States
(12) Patent Application Publication
(10) Pub. No.: US 2009/0251682 A1
(43) Pub. Date: Oct. 8, 2009

(54) BIOSENSOR

(75) Inventors: Cheng Wang, Taoyuan Hsien (TW); Ya-Ping Xie, Taoyuan Hsien (TW); Yu-Qin Tang, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/172,599

(22) Filed: Jul. 14, 2008

(30) Foreign Application Priority Data
Apr. 7, 2008 (TW) 97112507

(51) Int. Cl. G01N 1/00; G01B 9/02

(52) U.S. Cl. 356/36; 356/519

(57) ABSTRACT

A biosensor includes an external cavity laser device having an optical resonator with at least one total-reflection mirror and a semi-reflection mirror corresponding to the total-reflection mirror, wherein the total-reflection mirror includes a transparent substrate and a surface plasma resonance unit disposed on the transparent substrate. The total-reflection mirror includes a transparent substrate, and the surface plasma resonance unit is disposed on the transparent substrate.

### CROSS REFERENCE TO RELATED APPLICATIONS

This Application claims priority of Taiwan Patent Application No. 097112507, filed on Apr. 7, 2008, the entirety of which is incorporated by reference herein.

### BACKGROUND OF THE INVENTION

1. Field of the Invention

The present invention relates to a biosensor, and in particular relates to a surface plasma resonance sensor providing an external cavity laser device to perform resonance amplification, capable of optically amplifying a weak bioreaction signal for signal detection.

2. Description of the Related Art

Biosensors characterized with unique features are designed to utilize a specific enzyme or reactant to react with an analyzed object and then to design various biosensors based on the detected characteristics such as photonics, optics and mass before and after reaction. Meanwhile, because signals of biomolecular reactions are relatively weak, it is possible that a required signal might be covered by interference signals when the weak signal is mishandled. Surface plasma resonance (SPR) effect is a common method for detection of a bioreaction signal in the biosensor field.

The principle of the surface plasma resonance (SPR) detection method is to form an evanescent wave in the metallic film when the light beams have total reflection on the surface of the metallic film. When the resonance of the evanescent wave and the surface plasma wave exists, the reflected light intensity to be detected is greatly decreased. With respect to the surface plasma resonance sensor, detection sensibility can be increased by varying the structure of the metallic film and tested surface. In U.S. Pat. No. 5,991,048, for example, sensibility can be increased by a dielectric layer located between the metallic film and the detected surface. However, signals cannot be effectively amplified because only a single or several photon reflections are utilized by surface plasma resonance techniques.

To attain high detection precision of a biosensor, a large amount of money must be invested in detecting and treating weak bioreaction signals, thus, it is difficult to decrease production costs.

### BRIEF SUMMARY OF THE INVENTION

In view of the above issues, an object of the present invention is to provide a biosensor to optically amplify a weak bioreaction signal, thereby simplifying signal processing of the detection circuits.

To attain the described purpose, the biosensor mainly includes an external cavity laser device and a surface plasma resonance unit. The external cavity laser device includes an optical resonator having at least one total-reflection mirror and a semi-reflection mirror corresponding to the total-reflection mirror. The total-reflection mirror includes a transparent substrate. The surface plasma resonance unit is disposed on the transparent substrate. The main function of the optical resonator is to provide a photon to reciprocally travel in the optical resonator under stimulated emission when the photon passes through the gain medium, thereby amplifying the bioreaction signal. When the gain applied on the photon is greater than the loss, i.e., the input current is greater than the threshold current, the photon power is output in the form of laser. When the surface plasma resonance unit is irradiated by the photon, the majority of the energy is reflected to the optical resonator in the way of total-reflection, and part of the energy in the form of the evanescent wave is absorbed by the surface plasma resonance unit. When the fixed specific biomolecules located at the surface plasma resonance unit react with the analyzed object, the energy of the evanescent wave changes. Therefore, the photon energy reflected by the surface plasma resonance unit is modulated by the bioreaction signal of the surface plasma resonance unit, thereby resulting in a signal intensity of the output laser signal to be varied based on the variation of the bioreaction signal to optically amplify the bioreaction signal.

Two mirrors of the optical resonator of the external cavity laser device of the present invention are detachable individual portions with large volume thereof, and therefore to fix the specific biomolecules on the total-reflection mirror of the surface plasma resonance unit (e.g., metallic film) is relatively easy. The biosensor utilizing the external cavity laser device is applicable for manufacturing a relatively large-volume bioreaction analytical and testing instrument. By incorporating the multiple resonance amplifications of the external cavity laser device property, the invention is capable of providing a photon to be modulated by the surface plasma resonance of the total reflection mirror when the photon travels in the optical resonator to and fro for one time, wherein the energy of the photon is modulated relative to the surface biomolecular signal of the surface plasma resonance unit. When the photon reciprocally travels in the optical resonator, a biomolecular signal of the surface of the surface plasma resonance unit can be effectively amplified, thus allowing convenient detection of the weak bioreaction signal in a simplified manner.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective view of a biosensor according to an embodiment of the present invention;

FIG. 2 is a sectional view of a total-reflection mirror of the biosensor in FIG. 1;

FIGS. 3A to 3C are top views of different microchannels of the total-reflection mirror according to the embodiment of the present invention; and

FIG. 4 is a diagram of variation curves of output intensity of an external cavity laser device corresponding to the bioreaction signal.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

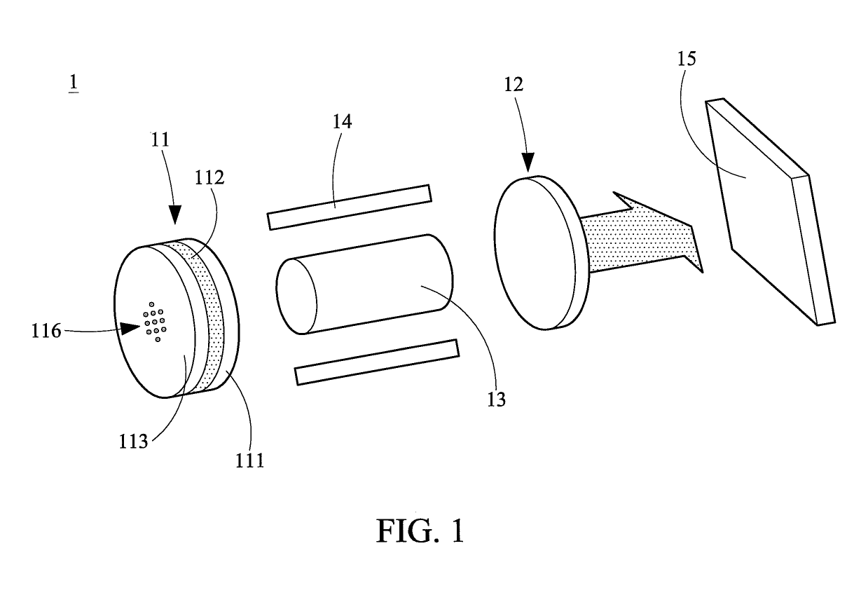

FIG. 1 is a perspective view of a biosensor 1 according to an embodiment of the present invention. The biosensor 1 includes an external cavity laser device and a surface plasma resonance unit 112. The external cavity laser device includes an optical resonator having at least one total-reflection mirror 11 and a semi-reflection mirror 12 corresponding to the total-reflection mirror 11. The total-reflection mirror 11 includes a transparent substrate 111, and the surface plasma resonance unit 112 is disposed on the transparent substrate 111 of the total-reflection mirror 11.

For example, the external cavity laser device can be a gas laser device (e.g., carbon dioxide laser device or helium-neon laser device), a solid-state laser device (e.g., neodymium-yttrium aluminum garnet (Nd:YAG) laser device), a dying laser device or a chemical laser device. In FIG. 1, the external cavity laser device is a Nd:YAG solid-state laser device, but it is not limited thereto. Two mirrors, i.e., the total-reflection mirror 11 and the semi-reflection mirror 12 of the optical resonator, can be plano-plano mirror, plano-convex mirror or plano-concave mirror. In FIG. 1, the two mirrors of the external cavity laser device are plano-plano mirrors, but they are not limited thereto. The transparent substrate 111 of the total-reflection mirror 11 can be a glass substrate coated with the surface plasma resonance unit 112 thereon. The surface plasma resonance unit 112 is a thin and high-reflective metallic film made of gold, silver, copper, or a composite layer thereof. The semi-reflection mirror 12 coated with a non total-reflection film (not shown) is a light outputting-reflection mirror (laser-output mirror) for partially reflecting and outputting laser, and the reflection rate of the non total-reflection film are designed according to the actual requirement. The surface plasma resonance unit 112 (metallic film) formed on the transparent substrate 111 of the total-reflection mirror 11 serves two functions. First, the total-reflection mirror 11 and the semi-reflection mirror 12 can constitute the optical resonator. Second, the surface plasma resonance (SPR) effect can be achieved. Thus, the laser in the optical resonator can be slightly modulated by the bioreaction formed on the surface plasma resonance unit 112.

The external cavity laser device further includes gain medium 13 and at least one pumping source 14, e.g., a Xenon lamp pump or a semiconductor laser pump, which is disposed beside the gain medium 13 to input energy to the gain medium 13, thus, causing the gain medium 13 to meet the population inversion condition. The gain medium 13, e.g., a neodymium-yttrium aluminum garnet (Nd:YAG) gain medium 13 bar, is disposed between the total-reflection mirror 11 and the semi-reflection mirror 12 to provide stimulated emission condition. When the pumping source 14 inputs energy to the gain medium 13, population inversion can be achieved by the gain medium 13. As the photon reciprocally travels in the optical resonator, stimulated emission occurs when the photon passes through the gain medium 13, thus, amplifying the bioreaction signal.

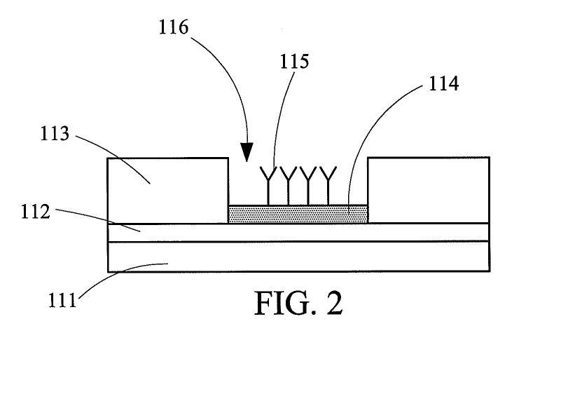

FIG. 2 is a sectional view of the total-reflection mirror of the biosensor in FIG. 1. The total-reflection mirror 11 further includes an insulating layer 113 and an adhesive layer 114. The insulating layer 113, which can be made of polymer material, is disposed on the surface plasma resonance unit 112 to form a sidewall of a microchannel 116 for an analyzed object. The adhesive layer 114 formed on the surface plasma resonance unit 112 located at the microchannel 116 for fixing specific biomolecules 115 to react with the corresponding biomolecules of the analyzed object. The specific biomolecules 115 include DNA fragment, antigen, antibody, enzyme, coenzyme and other small biomolecules. When the analyzed object is added, the specific biomolecules 115 react with corresponding biomolecules of the analyzed object, and therefore the reflection rate of the surface plasma resonance unit 112 is influenced.

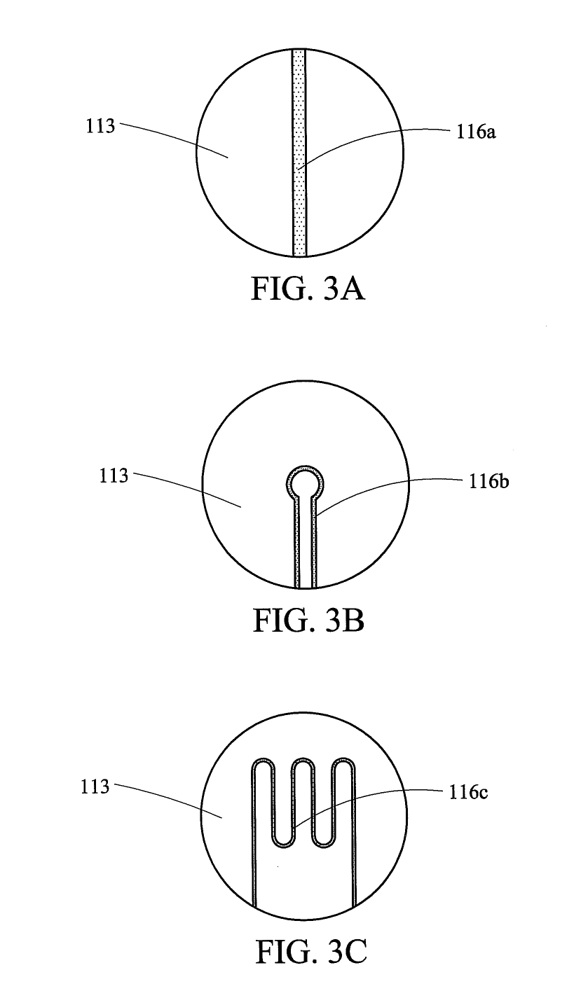

FIGS. 3A to 3C are top views of different microchannels of the total-reflection mirror according to the embodiment of the present invention. In FIG. 2, an exposed area of the surface plasma resonance unit 112 is the microchannel 116. In FIG. 3A, the microchannel 116 is a straight microchannel 116a. Because the laser beams of the optical resonator are approximately concentrated at the central region of the total-reflection mirror 11, the straight microchannel 116a passes through the central region of the total-reflection mirror 11, thus, increasing detection precision. In FIG. 3B, a circular microchannel 116b is provided for receiving the analyzed object to influence the reflection rate of the total-reflection mirror 11 by the SPR effect, and the content of the analyzed object is analyzed by detecting the variation of light-intensity output energy. Alternately, an S-shaped microchannel 116c of FIG. 3C can be adopted for increasing the effect of bioreaction influence of the laser power. It is possibly to concentrate the microchannel 116 at the central region of the total-reflection mirror 11.

The biosensor 1 further includes a light-intensity detector 15 which is disposed at the laser-emitting direction and corresponds to the laser wavelength of the external cavity laser device. The major function of the light-intensity detector 15 is to perform optoelectronic transformation and then to analyze the variation of the bioreaction signal according to the variation of photon power passing through a detection analysis treatment circuit.

A circular optical resonator (not shown in FIGs.) can be formed by three, four or more reflection mirrors, i.e., the circular optical resonator includes a plurality of total-reflection mirrors and one semi-reflection mirror (light outputting-reflection mirror), and the surface plasma resonance unit is disposed on the transparent substrate of one of the total-reflection mirrors. Therefore, the SPR effect of the surface plasma resonance unit can be performed thereon.

The SPR effect can be maximized by regulating the total-reflection angle of the surface plasma resonance unit, and therefore variation of laser output power can be maximized.

The major function of the optical resonator of the external cavity laser device of the embodiment is to provide a photon to reciprocally travel in the optical resonator. When the energy is input by the pump, the gain medium can satisfy population inversion condition. Stimulated emission occurs when the photon passes through the gain medium, and the photon is amplified by the stimulated emission. When the gain applied on the photon is greater than the loss, the photon power is output in the form of laser. When the surface plasma resonance unit is irradiated by the photon, the majority of the energy is reflected to the optical resonator in the way of total-reflection, and part of the energy in the form of the evanescent wave is absorbed by the surface plasma resonance unit. When the fixed specific biomolecules located at the surface plasma resonance unit reacts with the analyzed object, the energy of the evanescent wave is varied. Therefore, the photon energy reflected by the surface plasma resonance unit is modulated by the bioreaction signal of the surface plasma resonance unit, thereby resulting in varied output laser signal intensity according to the variation of the bioreaction signal to optically amplify the bioreaction signal. Because the output wavelength of the external cavity laser device is mainly influenced by the properties of the gain medium and the length of the optical resonator, the output wavelength of the external cavity laser device can be held steady when the properties of the gain medium and the length of the optical resonator are constant.

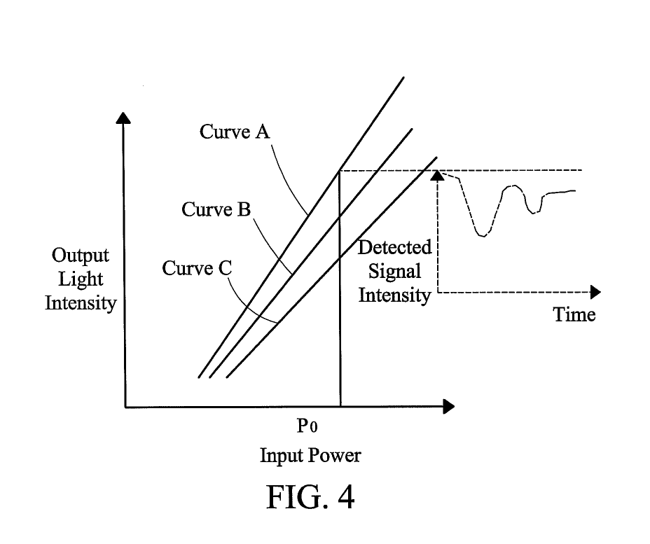

FIG. 4 is a diagram of variation curves of output intensity of an external cavity laser device corresponding to the bioreaction signal. A curve “A” shows the responsive relationship of the output light intensity relative to input power without adding the analyzed object. When the different liquids to be tested are added, the field intensity of the evanescent wave caused by the incident photon on the surface plasma resonance unit changes. Specifically, the reflection rate of the photon on the surface plasma resonance unit is influenced, and relatively changes the loss parameter of the laser, thereby resulting in different output light intensities relative to the input power P₀ in a responsive curve, as shown by a curve “B” or “C”. Under ideal conditions, when the input power P₀ is constant, the output light intensity of the laser should be held steady. If the bioreaction signal results in the variation of loss of the external cavity laser device, even if the input power does not change, the output light intensity of the laser still changes. Thus, the light-intensity detector can collect this variation signal, thereby obtaining the curve of the detected signal intensity with respect to the time period and immediately analyze the reaction states of the analyzed object and the specific biomolecules.

Based on the descriptions above, it is noted that two mirrors of the optical resonator of the external cavity laser device of the embodiment are detachable individual portions with large volume thereof. Additionally, those specific biomolecules to be fixed on the total-reflection mirror of the surface plasma resonance unit (e.g., metallic film) are relatively easily fulfilled, and the biosensor manufactured by the external cavity laser device is applicable for manufacturing a relatively large-volume bioreaction analytical and testing instrument. By incorporating the multiple resonance amplifications of the external cavity laser device property, the embodiment is capable of providing photon to be modulated by the surface plasma resonance of the total reflection mirror when the photon travels in the optical resonator to and fro for one time, wherein the energy of the photon is relatively modulated by the surface biomolecular signal of the surface plasma resonance unit. When the photon reciprocally travels in the optical resonator, the biomolecular signal of the surface of the surface plasma resonance unit can be effectively amplified. Thus, a weak bioreaction signal can be conveniently detected and the detecting process of the biosensor is simplified.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A biosensor, comprising:
an external cavity laser device comprising an optical resonator comprising at least one total-reflection mirror and a semi-reflection mirror corresponding to the total-reflection mirror; and
a surface plasma resonance unit coupled to the total-reflection mirror.

2. The biosensor as claimed in claim 1, wherein the total-reflection mirror comprises a transparent substrate, and the surface plasma resonance unit is disposed on the transparent substrate.

3. The biosensor as claimed in claim 2, wherein the transparent substrate comprises a glass substrate.

4. The biosensor as claimed in claim 1, wherein the surface plasma resonance unit comprises a metallic film, and the metallic film comprises gold, silver, copper, or a composite layer thereof.

5. The biosensor as claimed in claim 1, wherein the external cavity laser device comprises a gas laser device, a solid-state laser device, a dying laser device, a chemical laser device or a neodymium-yttrium aluminum garnet (Nd:YAG) laser device.

6. The biosensor as claimed in claim 5, wherein the gas laser device comprises carbon dioxide laser device or helium-neon laser device.

7. The biosensor as claimed in claim 5, wherein the external cavity laser device further comprises gain medium disposed between the total-reflection mirror and the semi-reflection mirror.

8. The biosensor as claimed in claim 7, wherein the gain medium comprises a neodymium-yttrium aluminum garnet (Nd:YAG) gain medium bar.

9. The biosensor as claimed in claim 7, wherein the external cavity laser device, further comprises a pumping source disposed beside the gain medium to input energy to the gain medium to achieve population inversion.

10. The biosensor as claimed in claim 9, wherein the pumping source comprises a Xenon lamp pump or a semiconductor laser pump.

11. The biosensor as claimed in claim 1, wherein the total-reflection mirror and the semi-reflection mirror of the optical resonator comprise plano-plano mirror, plano-convex mirror or plano-concave mirror.

12. The biosensor as claimed in claim 1, further comprising an insulating layer disposed on the surface plasma resonance unit to form a sidewall of a microchannel for an analyzed object.

13. The biosensor as claimed in claim 12, wherein the insulating layer comprises polymer material.

14. The biosensor as claimed in claim 12, wherein the microchannel comprises a straight microchannel, a circular microchannel or an S-shaped microchannel.

15. The biosensor as claimed in claim 12, wherein the microchannel is concentrated at a central region of the total-reflection mirror.

16. The biosensor as claimed in claim 12, further comprising an adhesive layer formed on the surface plasma resonance unit located at the microchannel for fixing specific biomolecules to be reacted with corresponding biomolecules of an analyzed object.

17. The biosensor as claimed in claim 16, wherein the specific biomolecules comprise DNA fragment, antigen, antibody, enzyme or coenzyme.

18. The biosensor as claimed in claim 1, further comprising a detector disposed at a laser-emitting direction for detecting light-intensity.

19. The biosensor as claimed in claim 1, wherein the optical resonator comprises a circular resonating cavity including a plurality of total-reflection mirrors and one semi-reflection mirror.

20. The biosensor as claimed in claim 19, wherein each of the total-reflection mirrors comprises a transparent substrate, and the surface plasma resonance unit is disposed on the transparent substrate of one of the total-reflection mirrors.
